(19) United States
(12) Patent Application Publication
(10) Pub. No.: US 2008/0318577 A1
(43) Pub. Date: Dec. 25, 2008

(54) METHOD AND APPARATUS FOR SUPPORTING INTER-FREQUENCY AND INTER-RADIO ACCESS TECHNOLOGY HANDOVER

(75) Inventors: Shankar Somasundaram, Deer Park, NY (US); Peter S. Wang, E. Setauket, NY (US); Jin Wang, Central Islip, NY (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL TECHNOLOGY CORPORATION, Wilmington, DE (US)

(21) Appl. No.: 12/143,931

(22) Filed: Jun. 23, 2008

Related U.S. Application Data
(60) Provisional application No. 60/945,973, filed on Jun. 25, 2007.

(51) Int. Cl. H04Q 7/22

(52) U.S. Cl. 455/436

(57) ABSTRACT

A method and apparatus for supporting inter-frequency and inter-radio access technology (inter-RAT) handover are disclosed. A network provides measurement gap parameters for configuring a measurement gap to a wireless transmit/receive unit (WTRU). The WTRU then performs a measurement based on the measurement gap parameters. Such measurement includes inter-frequency frequency division duplex (FDD) measurements, inter-RAT global standard for mobile communication (GSM) measurements, and inter-RAT universal mobile telecommunication system (UMTS) measurements.

### CROSS REFERENCE TO RELATED APPLICATIONS

This application claims the benefit of U.S. Provisional Application Ser. No. 60/945,973 filed on Jun. 25, 2007, which is incorporated by reference as if fully set forth.

### FIELD OF INVENTION

The application is related to wireless communication systems.

### BACKGROUND

The Third generation partnership project (3GPP) has recently initiated a long term evolution (LTE) program to bring new technology, new network architecture and configuration and new applications and services to the wireless cellular network in order to provide improved spectral efficiency, reduced latency, faster user experiences and richer applications and services with less cost. While LTE aims at realizing an evolved universal terrestrial radio access network (E-UTRAN), LTE concepts also apply to high speed packet access (HSPA) enhancements.

In previous universal mobile telecommunication system (UMTS) releases, there are three (3) kinds of handover scenarios: intra-frequency, inter-frequency and inter-RAT.

Intra-frequency handovers may be performed without a wireless transmit/receive unit (WTRU) tuning away from its current frequency. Inter-frequency and inter-RAT handovers require that the WTRU sequentially tune its radio to more than one frequency or RAT, e.g. global system for mobile communication (GSM), and UMTS, in order to perform measurements. In order to achieve this objective, a network signals compressed mode gap parameters to the WTRU which may be utilized by the WTRU to measure, detect and confirm an identity of the inter-frequency or inter-RAT cells. The signaled parameters may include measurement gap purpose, the measurement gap length, measurement gap duration, and other similar parameters.

A LTE network may have inter-frequency and inter-RAT handovers. In the case of inter-RAT handovers in LTE, there are two (2) RATs, GSM and UMTS. It is desirable to define new gap parameters, more specifically new measurement gap parameters, to facilitate handovers.

### SUMMARY

A method and apparatus for supporting inter-frequency and inter-RAT handover is defined. A network provides measurement gap parameters for configuring a measurement gap to a WTRU. The WTRU then performs measurements based on the measurement gap parameters. These measurements include, but are not limited to, inter-frequency frequency division duplex (FDD) measurements, inter-RAT GSM measurements, and inter-RAT UMTS measurements.

### BRIEF DESCRIPTION OF THE DRAWINGS

A more detailed understanding may be had from the following description, given by way of example in conjunction with the accompanying drawings wherein:

FIGS. 1-2 illustrate one example of a possible handover scenario; and

FIG. 3 shows an exemplary WTRU and eNB.

### DETAILED DESCRIPTION

When referred to hereafter, the terminology “WTRU” (wireless transmit/receive unit) includes but is not limited to a User Equipment (UE), a mobile station, a fixed or mobile subscriber unit, a pager, a cellular telephone, a personal digital assistant (PDA), a computer, or any other type of user device capable of operating in a wireless environment. When referred to hereafter, the terminology “evolved Node-B (eNB)” includes but is not limited to a Node-B (NB), base station, a site controller, an access point (AP), or any other type of interfacing device capable of operating in a wireless environment. A “measurement gap configuration” comprises at least one of a measurement gap parameter, neighboring cell list and other measurement information.

Measurement gap parameters are provided, that are signaled for inter-frequency and inter-RAT measurement and procedures, where the behavior of a WTRU under certain measurement gap patterns is unspecified. These measurement gap parameters are applicable to any wireless communication systems including, but not limited to, 3GPP UMTS, LTE, and HSPA enhancements (HSPA+). The measurement gap parameters facilitate handover procedures.

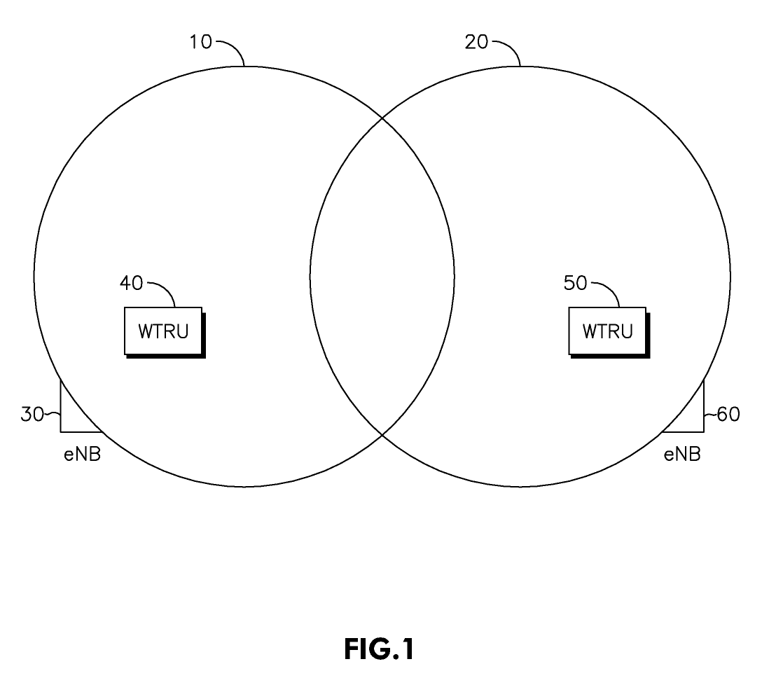

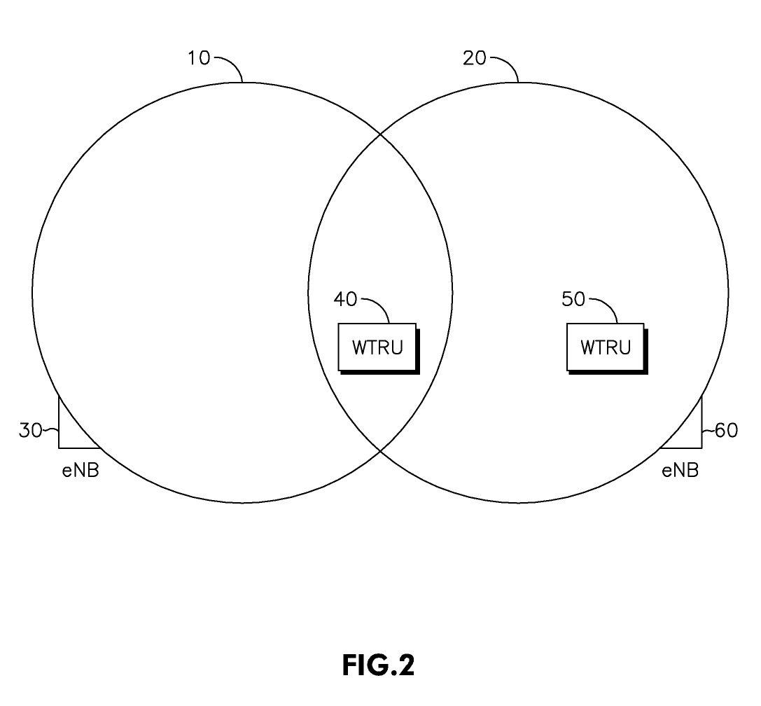

FIGS. 1-2 show an example of a possible handover (inter-RAT or inter-frequency) scenario. FIG. 1 represents the network state prior to a possible handover, where WTRU 40 is in cell 10 and is receiving signaling from eNB 30 and WTRU 50 is in cell 20 receiving signaling from eNB 60. In FIG. 1, WTRU 40 has moved into an area covered by cell 10 and cell 20 requiring a possible handover (HO). Prior to the HO, the WTRU 40 is configured to take one or more measurements, relative to cell 20, based upon measurement gap parameters specified by the eNB 30, examples of which are described below, according to measurement purposes, examples of which are also described below. Based upon the results of these measurements, eNB 30 will decide if the handover of WTRU 40 will take place.

The embodiments described below use LTE as a context for clarity. However, one skilled in the art will recognize that the new measurement gap parameters are applicable to many types of network environments.

In LTE, there are three different measurement scenarios: intra-frequency, inter-frequency, and inter-RAT. In LTE, since there are two RATs to measure, the measurement gaps may be used for at least three different purposes: inter-frequency FDD measurements, inter-RAT GSM measurements, and inter-RAT UMTS measurement. Other RATs are feasible and anticipated by this application. New parameters are defined that may be used to configure and activate the measurement gaps in the WTRU.

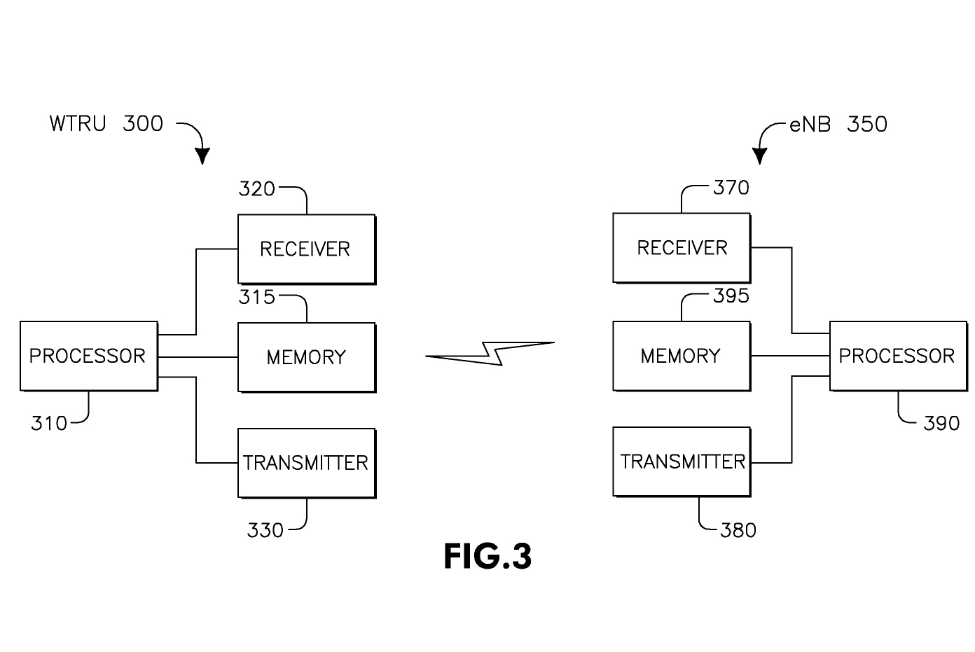

FIG. 3 shows representative examples of a WTRU 300 and an eNB 350. The eNB 350 processor 390 retrieves the measurement gap parameters from memory 395 and transmits the parameters to a WTRU 300 via transmitter 380. The WTRU 300 receives the measurement gap parameters via receiver 320. Processor 310 processes the parameters and stores them in memory 315. The processor 310 performs measurements based upon the stored parameters according to the behaviors and purposes described below.

Examples of these new parameters are defined in Table 1. The parameters in Table 1 may be referred to by a variety of names and yet still retain the same meaning.

TABLE 1

| Information | | | | |
|---|---|---|---|---|
| Element/Group | | | Type and | |
| name | Need | Multi | reference | Semantics description |
| Measurement gap | MP | 1 to | | |
| pattern sequence | | <maxMGPS> | | |
| (MGPS) | | | | |
| > Measurement Gap | MP | | MGPSI | Measurement Gap Pattern Sequence |
| Pattern Sequence | | | | Identifier establishes a reference to the |
| Identifier (MGPSI) | | | | measurement gap pattern sequence. |
| | | | | Up to <MaxMGPS> simultaneous |
| | | | | measurement gap pattern sequences |
| | | | | can be used |
| >MGPS Status Flag | MP | | Enumerated | This flag indicates whether the |
| | | | (activate, | Measurement Gap Pattern Sequence |
| | | | deactivate) | shall be activated or deactivated. |
| >Measurement gap | CV- | | Integer (0 . . . X) | Frame Number of the first frame of the |
| (MG) frame | Active | | | first measurement gap pattern within |
| Activation number | | | | the Measurement Gap Pattern |
| | | | | Sequence. |
| > Measurement gap | OP | | | |
| pattern sequence | | | | |
| configuration | | | | |
| parameters | | | | |
| >>MGMP | MP | | Enumerated | Measurement Gap pattern sequence |
| | | | (As | Measurement Purpose (MGMP). |
| | | | mentioned in | |
| | | | 4.1) | |
| >>MGPRC | MP | | Integer (0 to | The number of Measurement gap |
| | | | X) | patterns within the Measurement Gap |
| | | | | Pattern Sequence. |
| >>MGSN | MP | | Integer (0 | Measurement Gap Starting Sub-frame/ |
| | | | to X) | TTI Number (MGSN) |
| | | | | The sub-frame/symbol number of the |
| | | | | first Measurement gap sub- |
| | | | | frame/symbol within the “MG frame |
| | | | | Activation number” above. |
| >>Measurement gap | MP | | Integer (0 to | The length of the first Measurement |
| length (MGL)1 | | | X) | Gap within the Measurement gap |
| | | | | pattern |
| >>MGLn (n: 2 to X) | OP | | Integer (0 to | The length of the nth (any subsequent) |
| | | | X) | Measurement Gap within the |
| | | | | Measurement gap pattern |
| >>Measurement gap | MP | | Integer (0 to | Measurement gap distance indicates |
| distance (MGD) | | | X, | the number of sub frames/symbols |
| | | | undefined) | between starting sub frames of two |
| | | | | consecutive measurement gaps within |
| | | | | a measurement gap pattern. If there is |
| | | | | only one measurement gap in the |
| | | | | measurement gap pattern, this |
| | | | | parameter shall be set to undefined. |
| >>Measurrement gap | MP | | Integer | The duration of Measurement gap |
| pattern length | | | | pattern 1. |
| (MGPL)1 | | | | |
| >>Initial transmit | MP | | Enumerated | Initial Transmit Power can refer to the |
| power (ITP) | | | | need for any power adjustment after a |
| | | | | measurement gap period for uplink. |
| >>N Identify abort | CV- | | Integer(1 to | Indicates the maximum number of |
| | Initial | | X) | times the WTRU will use a |
| | BSIC | | | measurement gap pattern to attempt to |
| | | | | decode the unknown BSIC of the GSM |
| | | | | cell in the initial BSIC identification |
| | | | | procedure |
| >>T Reconfirm abort | CV-Re- | | Real(0.x by | Indicates the maximum time allowed |
| | confirm | | step of 0.y) | for the re-confirmation of the BSIC of |
| | BSIC | | | one GSM cell |
| | | | | in the BSIC re-confirmation procedure. |
| | | | | The time is given in steps of 0.5 |
| | | | | seconds. |
| >>N Abort UMTS | CV- | | | Indicates the maximum number of |
| | PSC | | | times the WTRU will use a |
| | decode | | | measurement gap pattern to attempt to |
| | | | | decode the UMTS cell in the PSC |
| | | | | detection procedure |
| >>> N Abort UMTS | OP | | | Indicates the maximum number of |
| P-SCH | | | | times the WTRU will use a |
| | | | | measurement gap pattern to attempt to |
| | | | | decode the Primary synchronization |
| | | | | channel |
| >>> N Abort UMTS | OP | | | Indicates the maximum number of |
| S-SCH | | | | times the WTRU will use a |
| | | | | measurement gap pattern to attempt to |
| | | | | decode the Secondary Synchronization |
| | | | | channel |
| >>> N Abort UMTS | OP | | | Indicates the maximum number of |
| PSC | | | | times the WTRU will use a |
| | | | | measurement gap pattern to attempt to |
| | | | | latch on to the scrambling code |
| >> T reconfirm Abort | CV- | | | Indicates the maximum time allowed |
| UMTS | Reconfirm- | | | for reconfirmation of the UMTS cells by |
| | PSC | | | just performing measurements on that |
| | | | | PSC |
| Number of | MP | | Integer | This is for Proposal 2 or 3 when one GP |
| Measurement | | | {0 . . . N} | will support more than one |
| Purposes In One Gap | | | | measurement purpose |
| of a gap pattern(GP) | | | | |
| Sequence of | MP | | Enumerated | The sequence will be according to the |
| Measurement | | | | assignment, but the elements are from |
| Purposes In One Gap | | | | the measurement purposes listed |
| | | | | below. |

When the measurement gap patterns are to be activated in a WTRU for an already configured measurement gap, the parameters in Table 2 may be used. The parameters in Table 2 may be referred to by a variety of names and yet still retain the same meaning.

TABLE 2

| Information | | | Type and | |
|---|---|---|---|---|
| Element/Group name | Need | Multi | reference | Semantics description |
| MG reconfiguration | MP | | Integer | Reconfigured frame number of the |
| frame activation number | | | (0 . . . X) | Measurement Gap Pattern |
| | | | | Sequence. |
| Measurement gap | MP | 1 to | | |
| pattern sequence | | <maxMGPS> | | |
| >MGPSI | MP | | MGPSI | Measurement Gap Pattern Sequence |
| | | | | Identifier |
| | | | | establishes a reference to the |
| | | | | measurement gap pattern sequence. |
| | | | | Up to <MaxMGPS> simultaneous |
| | | | | measurement gap pattern sequences |
| | | | | can be used |
| >MGPS Status Flag | MP | | Enumerated | This flag indicates whether the |
| | | | (activate, | Measurement Gap Pattern Sequence |
| | | | deactivate) | it shall be activated or deactivated. |
| >MG frame Activation | CV- | | Integer | Frame Number of the first frame of |
| number | Active | | (0 . . . X) | the first measurement gap pattern |
| | | | | within the Measurement Gap |
| | | | | Pattern Sequence. |

Measurement Gap Information and Uses

For inter-frequency measurements, the WTRU may need to perform conventional FDD measurements. For inter-RAT measurements for GSM, the WTRU may use the measurement gaps for any one or more of the following purposes as in UMTS:
Received signal strength indicator (RSSI) measurements;
Base station identity code (BSIC) Identification; and
BSIC reconfirmation.

In LTE, in some specific cases, the WTRU may perform a full frequency scan to lock onto a GSM cell.

For inter-RAT measurements for wideband code division multiple access (WCDMA), if the WTRU receives, in its neighboring cell list, UMTS absolute radio frequency channel numbers (UARFCNs) with a corresponding primary synchronization code (PSC), the WTRU may simply perform PSC reconfirmation.

For inter-RAT measurements for wideband code division multiple access (WCDMA), if the WTRU receives in its neighboring cell list, UMTS absolute radio frequency channel numbers (UARFCNs) without a corresponding primary synchronization code (PSC), the WTRU may use the measurement gaps for the following three step procedure:
Synchronization with a primary synchronization channel (P-SCH);
Synchronization with a secondary synchronization channel (S-SCH); and
Locking onto a scrambling code.

After the cell has been identified and measured, the network may provide a gap for reconfirming the existence of the PSC by performing measurements on it. This may be indicated to the WTRU by using an appropriate measurement purpose such as PSC reconfirmation.

Also in LTE, for some specific cases, the WTRU may perform a full frequency scan for locking onto the UMTS cell. In such cases, the measurement gap purpose may be any one or more of the following:
FDD measurements;
RSSI measurements;
BSIC identification;
BSIC reconfirmation;
P-SCH synchronization;
S-SCH synchronization;
PSC identification;
PSC reconfirmation;
GSM full frequency scan;
UMTS full frequency scan;
Time division duplex (TDD)—3.84 Mcps; and
TDD—1.28 Mcps.
   The last two of the above options may not be required if the network signals the absolute radio frequency channel numbers (ARFCNs) and the UARFCNs.

Alternatively, if the PSC is signaled in the neighboring cell list, or if the network configures the WTRU with a single measurement purpose for detecting and measuring the UMTS cell in one gap and configures the WTRU to use another gap for reconfirming the existence of the PSC, then the measurement gap purposes may be as follows:
FDD measurements;
RSSI measurements;
BSIC identification;
BSIC reconfirmation;
PSC detection;
PSC reconfirmation;
GSM full frequency scan;
UMTS full frequency scan;
TDD—3.84 Mcps; and
TDD—1.28 Mcps.
   The last two options of full frequency scan may not be needed if the network signals the ARFCNS and the UARFCNs.

Alternatively, the network may use a bitmap to signal the specific measurement purpose.

Behavior of a WTRU in Specific Measurement Gap Scenarios.

WTRU behaviors in a few example measurement scenarios are given hereinafter.

If there are multiple measurement gaps, if Gap 2 is signaled to start before Gap 1 ends, a WTRU behavior is undefined, or if Gap 2 exceeds a measurement gap pattern length, a WTRU behavior is undefined (or the WTRU rejects such a measurement configuration).

If an attempt to activate a measurement gap pattern for the same measurement purpose (MGMP) as an already active measurement gap pattern occurs, then a WTRU behavior is undefined (or the WTRU rejects such a measurement configuration).

If measurement gaps are sent more than once to the WTRU in the same cell, (e.g., once in a setup message and later in a handover message), and if both measurement gaps have the same sequence identifier, (i.e., measurement gap pattern sequence identifier (MGPSI)), then the most recent set of measurement gap parameters may be used by the WTRU to override the earlier set of measurement gap parameters.

If timing information is maintained during a handover and if no information on the measurement gap parameters is sent during the handover command, the WTRU may temporarily deactivate the measurement gap and reactivate it at the appropriately calculated or indicated sub-frame number in the new cell. In an inter-frequency handover, the neighboring cell list, if present, may need to be transmitted to the WTRU upon its entry into the new cell. If the WTRU does not receive the neighboring cell list upon its entry into the new cell, the WTRU will use its stored measurement configuration.

If timing information is not maintained during a handover, and if no information on the measurement gap parameters is sent during the handover command, the WTRU may temporarily deactivate the measurement gap and reactivate it at the appropriately calculated sub-frame number in the new cell or wait for an explicit activation message from the network with the sub-frame number to start the measurement gap in the new cell. In such case, in an inter-frequency handover, the neighboring cell list, if present, may need to be transmitted to the WTRU upon its entry into the new cell. If the WTRU does not receive the neighboring cell list upon its entry into the new cell, the WTRU will use its stored measurement configuration.

During a handover, if any new configuration or activation parameters are sent during an existing measurement gap in the handover command, the WTRU may continue to use the old measurement gap parameters in the new cell unless they are explicitly deactivated in the old cell. Alternatively, the WTRU may temporarily deactivate the measurement gap and reactivate it at the appropriately indicated or calculated sub-frame number in the new cell. In an inter-frequency handover, the neighbor cell list, if present, may need to be transmitted to the WTRU upon its entry into the new cell. If the WTRU does not receive the neighboring cell list upon its entry into the new cell, the WTRU will use its stored measurement configuration.

Although features and elements are described above in particular combinations, each feature or element can be used alone without the other features and elements or in various combinations with or without other features and elements. The methods or flow charts provided herein may be implemented in a computer program, software, or firmware incorporated in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, radio network controller (RNC), or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) or Ultra Wide Band (UWB) module.

What is claimed is:

1. A method for inter-frequency and inter-radio access technology (RAT) wireless transmit/receive unit (WTRU) handover in a long term evolution (LTE) environment comprising:
a WTRU receiving at least one measurement gap and at least one measurement gap parameter from a base station for configuring the measurement gap; and
the WTRU performing a measurement based on the measurement gap parameters including at least one of inter-frequency frequency division duplex (FDD) measurements, inter-RAT global system for mobile communication (GSM) measurements, and inter-RAT universal mobile telecommunication system (UMTS) measurement.

2. The method of claim 1 further comprising the WTRU performing a full frequency scan for locking onto a global standard for mobile communications (GSM) cell.

3. The method of claim 1 further comprising:
the WTRU receiving in a neighboring cell list (NCL), at least one universal mobile telecommunication system (UMTS) absolute radio frequency channel numbers (UARFCNs) and at least one corresponding primary synchronization code (PSC); and
the WTRU performing PSC reconfirmation.

4. The method of claim 1 further comprising:
the WTRU receiving in a neighboring cell list (NCL), at least one universal mobile telecommunication system (UMTS) absolute radio frequency channel number (UARFCN) without a corresponding primary synchronization code (PSC);
the WTRU synchronizing with a primary synchronization channel (P-SCH);
the WTRU synchronizing with a secondary synchronization channel (S-SCH); and
the WTRU locking onto a scrambling code.

5. The method of claim 1 further comprising the WTRU receiving a measurement purpose.

6. The method of claim 1 further comprising the WTRU performing a full frequency scan for locking onto a UMTS cell.

7. The method of claim 5, wherein the measurement purpose includes at least one of
frequency division duplex (FDD) measurements;
received signal strength indicator (RSSI) measurements;
base station identity code (BSIC) identification;
BSIC reconfirmation;
P-SCH synchronization;
S-SCH synchronization;
PSC identification;
PSC reconfirmation;
GSM full frequency scan;
UMTS full frequency scan;
time division duplex (TDD)—3.84 megachips per second (Mcps); and
TDD—1.28 Mcps.

8. The method of claim 1 further comprising receiving a PSC in a NCL and a reconfirming a PSC in a second measurement gap.

9. The method of claim 1 further comprising:
receiving a single measurement purpose further comprising detecting and measuring a UMTS cell in a first measurement gap; and
reconfirming a PSC in a second gap.

10. The method of claim 5 further comprising receiving a measurement purpose including at least one of frequency division duplex (FDD) measurements;
received signal strength indicator (RSSI) measurements;
base station identity code (BSIC) identification;
BSIC reconfirmation;
P-SCH synchronization;
S-SCH synchronization;
PSC identification;
PSC reconfirmation;
GSM full frequency scan;
UMTS full frequency scan;
time division duplex (TDD)—3.84 megachips per second (Mcps); and
TDD—1.28 Mcps.

11. The method of claim 5, wherein the measurement purpose may be received by the WTRU in a bitmap.

12. The method of claim 1, wherein the measurement gap parameter comprises at least one of the following:
a measurement gap pattern sequence (MGPS);
a number of measurement purposes in one measurement gap of a measurement gap pattern (GP); and
a sequence of measurement purposes in one gap.

13. The method of claim 12, wherein the MGPS comprises at least one of the following:
a MGPS identifier (MGPSI);
a MGPS status flag;
a measurement gap (MG) frame activation number; and
a measurement gap pattern sequence configuration parameter.

14. The method of claim 13, wherein the measurement gap pattern sequence configuration parameter comprises at least one of the following:
a measurement gap pattern sequence measurement purpose (MGMP);
a number of measurement gap patterns within the MGPS (MGPRC);
a sub-frame/symbol number of a first measurement gap sub-frame/symbol within the MG frame activation number;
a length of a first MG within the MG pattern;
a length of a subsequent Measurement Gap within the Measurement gap pattern;
a MG distance (MGD);
a duration of the first MG pattern;
an initial transmit power (ITP);
a maximum number of times that the WTRU will use a measurement gap pattern to attempt to decode the unknown base station identity code (BSIC) of a global system for mobile communication (GSM) cell;
a maximum time allowed for the re-confirmation of the BSIC of one GSM cell in a BSIC re-confirmation procedure;
a maximum number of times that the WTRU will use a measurement gap pattern to attempt to decode a UMTS cell in a PSC detection procedure; and
a maximum time allowed for reconfirmation of UMTS cells.

15. The method of claim 14, wherein the maximum number of times that the WTRU will use the measurement gap pattern to attempt to decode the UMTS cell in the PSC detection procedure further comprises the following:
a maximum number of times that the WTRU will use the measurement gap pattern to attempt to decode the Primary synchronization channel; and
a maximum number of times that the WTRU will use the measurement gap pattern to attempt to latch on to a scrambling code.

16. The method of claim 15 wherein if the measurement gap patterns are to be activated in the WTRU for an already configured measurement gap, the measurement gap parameter further comprises a reconfigured frame number of the MGPS.

17. The method of claim 16, wherein if a second measurement gap is signaled to start before a first measurement gap ends, the WTRU rejects signaled information in the second measurement gap.

18. The method of claim 17, wherein if the second measurement gap exceeds a measurement gap pattern length, the WTRU rejects signaled information in the second measurement gap.

19. The method of claim 1, wherein if measurement gaps are sent more than once in a same cell and if the first and second measurement gaps have the same sequence identifier, then the most recent set of measurement gap parameters are used by the WTRU overriding the earlier set of measurement gap parameters.

20. The method of claim 1 further comprising:
the WTRU deactivating the measurement gap if timing information is maintained during a handover and if no information on the measurement gap parameters is sent during the handover command.

21. The method of claim 20 further comprising the WTRU reactivating the measurement gap at a calculated sub-frame number in a new cell.

22. The method of claim 20 further comprising:
the WTRU waiting for an activation message with the sub-frame number; and
the WTRU starting the measurement gap in the new cell.

23. The method of claim 20 further comprising the WTRU retaining a measurement configuration at handover.

24. The method of claim 20 further comprising the WTRU receiving a NCL, upon entry into the new cell.

25. The method of claim 23 further comprising the WTRU using the measurement configuration if a NCL is not provided upon entry into the new cell.

26. The method of claim 1 further comprising:
the WTRU deactivating the measurement gap, if timing information is not maintained during a handover, and if no information on the measurement gap parameters is sent during a handover command.

27. The method of claim 26 further comprising the WTRU reactivating the measurement gap at a calculated sub-frame number in a new cell.

28. The method of claim 26 further comprising:
the WTRU waiting for an activation message with the sub-frame number; and
the WTRU starting the measurement gap in the new cell.

29. The method of claim 26 further comprising the WTRU retaining the measurement configuration at handover.

30. The method of claim 26 further comprising the WTRU receiving a NCL, upon entry into the new cell.

31. The method of claim 29 further comprising the WTRU using the measurement configuration if a NCL is not provided upon entry into the new cell.

32. The method of claim 1 further comprising:
the WTRU deactivating the measurement gap if no information on the measurement gap parameters is sent during a handover command.

33. The method of claim 32 further comprising the WTRU reactivating the measurement gap at a calculated sub-frame number in a new cell.

34. The method of claim 32 further comprising:
the WTRU waiting for an activation message with the sub-frame number; and
the WTRU starting the measurement gap in the new cell.

35. The method of claim 1 wherein the measurement gap parameters are new configuration or activation parameters.

36. The method of claim 35 further comprising:
the WTRU continuing to use at least one of the old measurement gap parameter in a new cell.

37. The method of claim 35 further comprising:
the WTRU deactivating the measurement gap at handover; and
the WTRU reactivating the measurement gap at the appropriately calculated sub-frame number in a new cell.

38. The method of claim 35 further comprising:
the WTRU waiting for an activation message with the sub-frame number; and
the WTRU starting the measurement gap in the new cell.

39. The method of claim 35 further comprising the WTRU retaining the measurement configuration unchanged at handover.

40. The method of claim 35 further comprising the WTRU receiving a NCL, upon entry into the new cell.

41. The method of claim 39 further comprising the WTRU using the measurement configuration if a NCL is not provided upon entry into the new cell.

42. A wireless transmit/receive unit (WTRU) operable in a long term evolution (LTE) environment comprising:
a receiver for receiving at least one measurement gap and at least one measurement gap parameter from a base station for configuring the measurement gap; and
a processor for performing a measurement based on the measurement gap parameters including at least one of inter-frequency frequency division duplex (FDD) measurements, inter-RAT global system for mobile communication (GSM) measurements, and inter-RAT universal mobile telecommunication system (UMTS) measurement.

43. The WTRU of claim 42 further comprising:
the processor configured to perform a full frequency scan for locking onto a global standards for mobile communications (GSM) cell.

44. The WTRU of claim 42 further comprising:
the receiver configured to receive in a neighboring cell list (NCL), at least one universal mobile telecommunication system (UMTS) absolute radio frequency channel numbers (UARFCNs) and at least one corresponding primary synchronization code (PSC); and
the processor further configured to perform PSC reconfirmation.

45. The WTRU of claim 42 further comprising:
the receiver further configured to receive in a neighboring cell list (NCL), at least one universal mobile telecommunication system (UMTS) absolute radio frequency channel number (UARFCN) without a corresponding primary synchronization code (PSC);
the processor further configured to synchronize with a primary synchronization channel (P-SCH);
the processor further configured to synchronize with a secondary synchronization channel (S-SCH); and
the processor further configured to lock onto a scrambling code.

46. The WTRU of claim 42 further comprising:
the receiver further configured to receive a measurement purpose.

47. The WTRU of claim 42 further comprising:
the processor further configured to perform a full frequency scan for locking onto a UMTS cell.

48. The WTRU of claim 46, wherein the measurement purpose includes at least one of
frequency division duplex (FDD) measurements;
received signal strength indicator (RSSI) measurements;
base station identity code (BSIC) identification;
BSIC reconfirmation;
P-SCH synchronization;
S-SCH synchronization;
PSC identification;
PSC reconfirmation;
GSM full frequency scan;
UMTS full frequency scan;
time division duplex (TDD)—3.84 megachips per second (Mcps); and
TDD—1.28 Mcps.

49. The WTRU of claim 42 further comprising:
the receiver further configured to receive a PSC in the NCL; and
the processor further configured to reconfirm a PSC in a second gap.

50. The WTRU of claim 42 further comprising:
the receiver further configured to receive a single measurement purpose wherein the measurement purpose further includes UMTS cell detection and measurement in a first measurement gap; and
the processor further configured to reconfirm a PSC in a second gap.

51. The WTRU of claim 46, wherein the measurement gap purpose further includes at least one of
frequency division duplex (FDD) measurements;
received signal strength indicator (RSSI) measurements;
base station identity code (BSIC) identification;
BSIC reconfirmation;
P-SCH synchronization;
S-SCH synchronization;
PSC identification;
PSC reconfirmation;
GSM full frequency scan;
UMTS full frequency scan;
time division duplex (TDD)—3.84 megachips per second (Mcps); and
TDD—1.28 Mcps.

52. The WTRU of claim 46, wherein the measurement purpose may be received in a bitmap.

53. The WTRU of claim 42, wherein the measurement gap parameter comprises at least one of the following:
a measurement gap pattern sequence (MGPS);
a number of measurement purposes in one gap of a measurement gap pattern (GP); and a sequence of measurement purposes in one gap.

54. The WTRU of claim 53, wherein the MGPS comprises at least one of the following:
a MGPS identifier (MGPSI);
a MGPS status flag;
a measurement gap (MG) frame activation number; and
a measurement gap pattern sequence configuration parameter.

55. The WTRU of claim 54, wherein the measurement gap pattern sequence configuration parameter comprises at least one of the following:
a measurement gap pattern sequence measurement purpose (MGMP);
a number of measurement gap patterns within the MGPS (MGPRC);
a sub-frame/symbol number of a first measurement gap sub-frame/symbol within the MG frame activation number;
a length of a first MG within the MG pattern;
a length of a subsequent MG within the measurement gap pattern;
a MG distance (MGD);
a duration of the first MG pattern;
an initial transmit power (ITP);
a maximum number of times a measurement gap pattern is used to attempt to decode the unknown base station identity code (BSIC) of a global system for mobile communication (GSM) cell;
a maximum time allowed for the re-confirmation of the BSIC of one GSM cell in a BSIC re-confirmation procedure;
a maximum number of times that a measurement gap pattern is used to attempt to decode a UMTS cell in a PSC detection procedure; and
a maximum time allowed for reconfirmation of UMTS cells.

56. The WTRU of claim 55, wherein the maximum number of times that the measurement gap pattern is used to attempt to decode a UMTS cell in a PSC detection procedure further comprises the following:
a maximum number of times that a measurement gap pattern is used to attempt to decode the Primary synchronization channel; and
a maximum number of times that a measurement gap pattern is used to attempt to latch on to a scrambling code.

57. The WTRU of claim 56, wherein if the measurement gap patterns are to be activated for an already configured measurement gap, the measurement gap parameter further comprises a reconfigured frame number of the MGPS.

58. The WTRU of claim 57, wherein if a second gap is signaled to start before a first gap ends, the WTRU rejects signaled information in the second gap.

59. The WTRU of claim 58, wherein if the second gap exceeds a measurement gap pattern length, the WTRU rejects signaled information in the second gap

60. The WTRU of claim 42, wherein if measurement gaps are sent more than once in a same cell and if the first and second measurement gaps have the same sequence identifier, then the most recent set of measurement gap parameters are used by the WTRU overriding the earlier set of measurement gap parameters.

61. The WTRU of claim 42 further comprising:
the processor further configured to deactivate the measurement gap if timing information is maintained during a handover and if no information on the measurement gap parameters is sent during the handover command; and
the processor further configured to reactivate the measurement gap at a calculated sub-frame number in a new cell.

62. The WTRU of claim 61 further comprising:
the receiver further configured to wait for an activation message with the sub frame number; and
the processor further configured to start the measurement gap.

63. The WTRU of claim 61 further comprising the processor further configured to retain a measurement configuration at handover.

64. The WTRU of claim 61 further comprising the receiver further configured to receive a NCL upon entry into the new cell.

65. The WTRU of claim 63 further comprising the processor further configured to process the measurement configuration if a NCL is not provided upon entry into the new cell.

66. The WTRU of claim 42 further comprising the processor configured to deactivate the measurement gap if timing information is not maintained during a handover, and if no information on the measurement gap parameters is sent during a handover command.

67. The WTRU of claim 66 further comprising the processor configured to reactivate the measurement gap at a calculated sub-frame number in a new cell.

68. The WTRU of claim 66 further comprising the receiver configured to wait for an activation message with the sub-frame number; and
the processor configured to start the measurement gap in the new cell.

69. The WTRU of claim 66 further comprising the processor configured to retain the measurement configuration at handover.

70. The WTRU of claim 66 further comprising the receiver configured to receive a NCL, upon entry into the new cell.

71. The WTRU of claim 66 further comprising the processor configured to process a stored measurement configuration if a NCL is not provided upon entry into the new cell.

72. The WTRU of claim 42 further comprising the processor configured to deactivate the measurement gap if no information on the measurement gap parameters is sent during a handover command.

73. The WTRU of claim 72 further comprising the processor reactivating the measurement gap at a calculated sub-frame number in a new cell.

74. The WTRU of claim 72 further comprising:
the receiver configured to wait for an activation message with the sub-frame number; and
the processor configured to start the measurement gap in the new cell.

75. The WTRU of claim 42, wherein the measurement gap parameters are new configuration or activation parameters.

76. The WTRU of claim 75 further comprising the processor configured to continue to process at least one of the old measurement gap parameters in a new cell.

77. The WTRU of claim 75 further comprising the processor configured to:
deactivate the measurement gap at handover; and
reactivate the measurement gap at the appropriately calculated sub-frame number in a new cell.

78. The WTRU of claim 75 further comprising:
the receiver configured to wait for an activation message with the sub-frame number; and
the processor configured to start the measurement gap in the new cell.

79. The WTRU of claim 75 further comprising the processor configured to retain a measurement configuration at handover.

80. The WTRU of claim 75 further comprising the receiver configured to receive a NCL upon entry into the new cell.

81. The WTRU of claim 79 further comprising the processor configured to process the measurement configuration if a NCL is not provided upon entry into the new cell.
